(19) United States
(12) Patent Application Publication
(10) Pub. No.: US 2013/0340958 A1
(43) Pub. Date: Dec. 26, 2013

(54) Hatch screen

(71) Applicant: Roy Austin Floumoy, JR., Milton, VT (US)

(72) Inventor: Roy Austin Floumoy, JR., Milton, VT (US)

(21) Appl. No.: 13/507,382

(22) Filed: Jun. 25, 2012

(51) Int. Cl. E06B 9/52

(52) U.S. Cl. 160/371

(57) ABSTRACT

A flexible insect screen for hatches and/or openings that do not have insect screens.

### CROSS-REFERENCE TO RELATED APPLICATIONS

U.S. Pat. No. 2,717,437

### BACKGROUND OF THE INVENTION

The purpose of this invention is to address deficiencies in existing hatches and openings that do not have an insect screen. Boat deck hatches are a specific example although the invention is applicable to any hatch or opening that does not have an insect screen.

### BRIEF SUMMARY OF THE INVENTION

The correction of this deficiency is by the application of a removable, flexible insect screen to the inside surface around the hatch or opening. If applied to a hatch, the open direction is outward, away from the invention. This location avoids conflict between the invention and the open hatch. The flexible material allows the screen to conform to the surface around the hatch or opening. Boat deck hatches as a specific example would have the invention applied to the underside of the deck, inside the boat, with the hatch opening outwards and upwards.

### DETAILED DESCRIPTION OF THE INVENTION

The invention is comprised of two components—

### 1. The Screen

a. Sized larger than the hatch opening with similar configuration.

b. The edges have a sewn fabric border, running continuous and enclosing the perimeter of the Screen.

c. The fabric border has a one half of a hook and loop fastener applied to one side of the border, running continuous and enclosing the perimeter of the Screen.

d. The area between, and within, the continuous perimeter flexible fabric borders is comprised of flexible insect screen.

### 2. The Receiver

a. Sized the same as the Screen with identical configuration.

b. Comprised of the sewn fabric border only, identical in size, dimension and configuration of the Screen border.

c. The fabric border has the opposite half of the hook and loop fastener that is on the Screen fabric border.

d. The remaining area inside the fabric border is open without any material.

Application and Installation—

### 1. The Receiver

a. Applied by adhesive or mechanical fasteners to the inside surface area around the existing hatch in identical configuration to the Screen.

b. The final installation of the Receiver must have the hook and loop fastener exposed to receive the Screen.

### 2. The Screen

a. The Screen is applied to the Receiver by aligning the borders of the Receiver and the Screen so that the hook and loop fasteners on each border can connect.

### BRIEF DESCRIPTION OF THE SEVERAL VIEWS OF THE DRAWING

Drawing 1 shows the Receiver, the Screen and the hatch opening. The invention is shown sized larger that the hatch opening. The drawing shows how the Receiver would be applied to the surface around the hatch. The drawing shows how the Receiver and the Screen align and connect. The finish installation would have the screen over the hatch opening.

### DRAWINGS AND PHOTOS

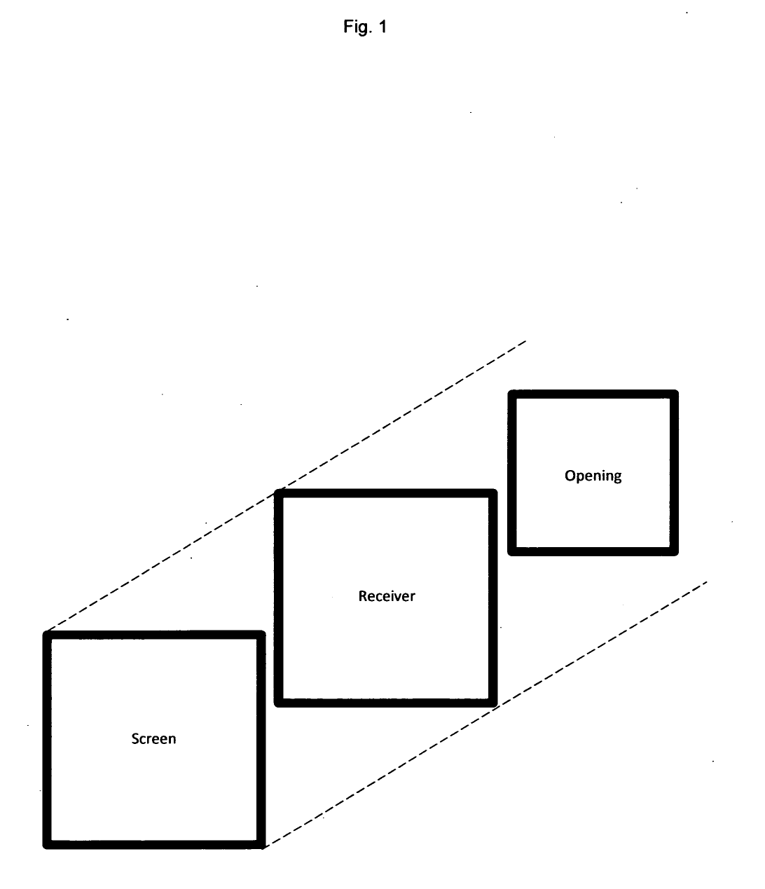

Drawing labeled FIG. 1 is attached.

1. The claim is for the two component flexible insect screen system comprising of the “Receiver” and the “Screen” and any variations thereof. The application of which is to remedy openings and/or hatches that do not have insect screens.
